(19) United States
(12) Patent Application Publication
(10) Pub. No.: US 2012/0002055 A1
(43) Pub. Date: Jan. 5, 2012

(54) Correlation of position data that are acquired by means of a video tracking system with a second localization system

(76) Inventors: Walter Englert, Burgrieden (DE); Christian Holzer, Muenchen (DE); Florian Hoeflinger, Muenchen (DE)

(21) Appl. No.: 12/934,407

(22) PCT Filed: Mar. 13, 2009
(86) PCT No.: PCT/EP2009/001850

§ 371 Date: Sep. 15, 2011

(30) Foreign Application Priority Data
Mar. 28, 2008 (DE) 102008016200.0

(51) Int. Cl. H04N 5/225

(52) U.S. Cl. 348/169; 348/E05.024

(57) ABSTRACT

The invention relates to a video tracking system which determines the position of objects, e.g. players in a football match, by evaluating video image information. According to the present invention, the video tracking system is additionally provided with an independent positioning system which is preferably used in instances when the video-based position detection is faulty or does not work at all. According to one embodiment, the independent positioning system is GPS based, each football player carrying a portable GPS module which transmits the position data to the system by radio. Additional data, such as heart rate or acceleration, can also be transmitted.

### CROSS-REFERENCE TO RELATED APPLICATION

This application is a U.S. National Phase entry of PCT/EP2009/001850 filed Mar. 13, 2009, and claims priority to German Patent Application No. 102008016200.01 filed Mar. 28, 2008, each of which is incorporated herein by references hereto.

### BACKGROUND OF THE INVENTION

The invention relates to video tracking systems in general, and in particular to systems by means of which the position of one or of a plurality of video-tracked objects is ascertained.

Video tracking systems are described e.g. in German patent application DE 10 2007 032 259.5, US patent application 60/949,075 and in the international patent application PCT/EP2007/011128. Such video tracking systems are e.g. suitable for recording the field on which a football match takes place with one or a plurality of video cameras and for localizing the players. It is thus possible to ascertain for each individual player on the field the associated position at any time.

This may become problematic e.g. when two players meet on the field and then move away from each other. In these cases it may happen that the video tracking system is not able to reliably associate the players moving away from each other with the respective players prior to their encounter. This may result in an exchange of identity that has to be corrected manually.

It is therefore the object of the present invention to provide a video tracking system in the case of which objects can be tracked reliably and without manual correction even when objects approach one another in the video representation.

This object is achieved by the invention disclosed in the independent claims.

Preferred embodiments are disclosed in the subclaims.

The invention especially suggests that, in addition to positioning with the aid of the video tracking system, a second position detection, which is independent of the first one, should be executed, said second position detection being especially used in cases where object tracking by means of the video shots cannot be executed reliably. In the example of a football match in which the individual football players are the objects, GPS positioning can, for example, be carried out (GPS: “Global Positioning System”). To this end, each player carries a GPS module which transmits the player's position data to a computer system connected to the video tracking system. If the video tracking system is not able to reliably ascertain the identity of a player on the basis of the video shots (i.e. if the video-based position detection is faulty or does not work at all), the system will resort to the GPS data and correlate the video position data with the aid of the GPS data so as to correct, if necessary, the association of video objects with players and reverse an exchange of identity that may have taken place.

According to a preferred embodiment, the GPS position data are only evaluated when localization of the players with the aid of the video shots is doubtful. According to a different embodiment, the correlation is executed permanently.

It follows that, according to the present invention, two separate localization mechanisms are used, which are technically independent of one another, the high location accuracy and the high data rate (number of positions ascertained per second) being preserved.

According to a particularly preferred embodiment, the GPS module carried by the players, which transmits the position data to the system by radio, is operated by a lithium polymer battery, which can be charged by induction. The module to be carried by the player is preferably equipped with a microcontroller which has an interface and via which the module can be programmed. According to a preferred embodiment, the player's module is fully potted and has therefore a particularly high mechanical stability.

Another embodiment is so conceived that, in addition to the localization function, the module to be carried by the player fulfils further tasks. The module may, for example, receive heart rate data or other medical data via a short-range radio link from a sternum strap or other detectors worn close to the body, and transmit these data to the video tracking system or a separate computing device by radio. The short-rang radio communication preferably takes place in a suitable frequency range, e.g. in an ISM band at 2.4 GHz. The above-mentioned programming interface may be the same short-range radio link that is also used for data transmission.

Alternatively or additionally, other types of sensor data, such as acceleration data, may also be acquired and transmitted to the system by radio. According to one embodiment of the invention, the associated sensors may also be activated via the short-range radio link. According to another embodiment, the associated sensors are hard-wired within the (possibly potted) player's module.

Instead of the above-mentioned GPS system, other satellite-based positioning systems may also be used, e.g. Galileo, GLONASS, COMPASS or IRNSS. In other embodiments positioning systems which are not satellite based may also be used. Such positioning means may e.g. evaluate signals of a plurality of radio base stations (GSM, UMTS etc.) or cordless base stations (WLAN, DECT etc.) for the purpose of localization. Alternatively, ultrasonic localization systems as well as proprietary radiolocation systems may be used.

In addition, the video tracking system preferably has the characteristics described in the applications DE 10 2007 032 259.5, U.S. 60/949,075 and PCT/EP2007/011128. The disclosed content of these applications is explicitly incorporated into the present application by reference.

1. A video tracking device for tracking the position of objects in video images, characterized in that
a localization system, which is independent of video image-based position detection, is used, at least temporally, for verifying the positions ascertained by video-based position detection or for acquiring position data, when the video-based position detection is faulty or does not work at all, said independent localization system comprising at least one portable localization device comprising a detector for detecting the current position of the portable localization device, and a transmitter for transmitting the detected position to a video tracking device.

2. A video tracking device according to claim 1, wherein the independent localization system is used for ascertaining object positions, when at least two objects in the video representation approach one another such that a reliable identification of the objects is not possible.

3. A video tracking device according to claim 1 or 2, wherein the independent localization system is GPS-based.

4. A system comprising
a video tracking device for tracking the position of objects in video images, and
at least one portable localization device, comprising:
a detector for detecting the current position of the portable localization device; and
a transmitter for transmitting the detected position to a video tracking device.

5. A system according to claim 4, said at least one portable localization device further comprising:
a data receiver for receiving non-position data,
and wherein the portable localization device is adapted to transmit also the non-position data by means of the transmitter to the video tracking device.

6. A system according to claim 5, wherein the data receiver is a short-range radio receiver.

7. A system according to claim 6, wherein the short-range radio receiver operates in the 2.4 GHz band.

8. A method of operating a video tracking system, comprising:
acquiring first position data of at least one video-tracked object by analyzing video image information;
acquiring second position data of the at least one video-tracked object making use of a localization system that is not video-based, comprising
at least one portable localization device comprising
a detector for detecting the current position of the portable localization device; and
a transmitter for transmitting the detected position to the video tracking system, and
correlating the first position data and the second position data for acquiring position information of the at least one video-tracked object.

9. A method according to claim 8, wherein first and second position data of at least two video-tracked objects are acquired, and wherein the correlation step comprises:
correcting an incorrect assignment of first position data to respective video-tracked objects by evaluating the second position data.
